(19) United States
(12) Patent Application Publication
(10) Pub. No.: US 2023/0325595 A1
(43) Pub. Date: Oct. 12, 2023

(54) Enhancement of Bootstrapping for Information Extraction

(71) Applicant: Siemens Aktiengesellschaft, München (DE)

(72) Inventor: Pankaj Gupta, München (DE)

(73) Assignee: Siemens Aktiengesellschaft, München (DE)

(21) Appl. No.: 18/040,714

(22) PCT Filed: Aug. 5, 2020
(86) PCT No.: PCT/EP2020/072042

§ 371 Date: Feb. 6, 2023

(51) Int. Cl. G06F 40/279; G06F 40/30

(52) U.S. Cl. CPC G06F 40/279; G06F 40/30

(57) ABSTRACT

Various embodiments of the teachings herein include a computer-implemented method for enhancing reliability of bootstrapping for information extraction, IE. For example, the method may include: performing relation extraction, RE, to acquire a seed instance including a pair of entities and relationship information between the pair of entities; finding seed occurrences which match to the seed instance in a document collection; generating a set of extraction patterns corresponding to the relationship information by clustering the seed occurrences, wherein each of the extraction patterns is mapped to one of clusters of the seed occurrences; generating a graph which represents similarity between the extraction patterns based on word embedding vectors for each of the extraction patterns; identifying at least one noisy extraction pattern among the set of the extraction patterns based on the similarity and a pre-defined threshold; and rectifying the set of extraction patterns by removing the identified noisy extraction pattern.

### CROSS-REFERENCE TO RELATED APPLICATIONS

This application is a U.S. National Stage Application of International Application No. PCT/EP2020/072042 filed Aug. 5, 2020, which designates the United States of America, the contents of which are hereby incorporated by reference in their entirety.

### TECHNICAL FIELD

The present disclosure relates to Natural Language Processing (NPL). Various embodiments of the teachings herein include systems and/or methods for NPL.

### BACKGROUND

Information extraction is one of the key techniques of Natural Language Processing that identifies and extracts relevant information hidden in large industrial corpora as well from the plethora of data available on internet. The relevant information is particularly hidden in unstructured form of text, for example in text documents, blogs, service reports, tenders, specification documents, standardization documents, etc.

Information extraction engine has two major components: Entity Extraction (detecting entities such as person, organization location, products, technologies, etc.) and Relation Extraction (detecting relationship between pairs of nominals or entities such as supplier-of, acquired-by, etc.).

Particularly, Relationship Extraction (RE) transforms unstructured text into relational triples, each representing a relationship between two named-entities. To expand a set of initial seed relationships, a bootstrapping technique can be utilized. In other word, the objective of bootstrapping is to expand the seed set with new relationship instances.

However, these bootstrapping approaches often experience with semantic drift problems due to lack of labeled data, where the target semantics “drift” due to no supervision. Semantic drift means the progressive deviation of the semantics for the extracted relationships from the semantics of the seed relationships. For instance, a user bootstraps the system to extract all fact (subject-relationship-object) for ‘acquired’ relationship using seed <Siemens AG, Acquired, Mendix>. The information extraction system also extracts a triple <Siemens AG, Said-to, Mendix>, because those two entities factually have this relationship. In this case, the information extraction system incorrectly marks the triple, which includes ‘Said-to’ relationship, to be recognized as the ‘acquired’ relationship. However, the information extraction system cannot distinguish that the instance does not possess ‘acquired’ relationship due to no data annotation at the instance level.

Therefore, it may be required to reduce and control the semantic drift and noise propagation iteratively in bootstrapping for relation extraction in order to precisely extract relevant information underlying in the large-scale unstructured industrial corpora and web.

In Salton and Berkely et al., “Term-weighting approaches in automatic text retrieval”, Information Processing and Management, 1988 (hereafter cited as “Salton and Berkely et al.”), expanding seed set by relying on TF-IDT, term frequency-inverse document frequency, is described. However, such approach has limitations, since the similarity between any two relationship instance vectors of TF-IDF weights is only positive when the instances share at least one term. For instance, the phrases “was founded by” and “is the co-founder of” do not have any common words, but they have the same semantics (or: meaning).

In Brin et al., “Extracting Patterns and Relations from the World Wide Web”, Selected Papers from the International Workshop on The World Wide Web and Database, 1999 (hereafter cited as “Brin et al.”), DIPRE generating extraction patterns by grouping contexts based on string matching is described, which controls semantic drift by limiting the number of instances.

In Agichtein and Gravano et al., “Snowball: Extracting Relations from Large Plain-Text Collections”, Processings of the ACM Conference on Digital Libraries, 2000 (hereinafter cited as “Gravano et al.”), a bootstrapping having the processing phases: find seed matches, generating extraction patterns, finding relationship instances, and detecting semantic drift is described.

In Gupta et al, “Joint Bootstrappong Machines for High Confidence Relation Extraction”, NAACL 2018 (hereinafter cited as “Gupta et al.”), semi-supervised approaches to extract relevant information via bootstrapping approaches using very few data annotations is described.

In Jacob Devlin et al, “BERT: Pre-training of Deep Didirectional Transformers for Language Understanding” NAACL 2019, a language model is describe.

In Liu et al, “RoBERTa: A Robustly Optimized BERT Pretraining Approach”, 2019, a language model is described.

In Petroni et al, “Language Models as Knowledge Based?”, EMLP 2019, a language model is described.

### SUMMARY

The teachings of the present disclosure include methods and/or systems for enhancing reliability of bootstrapping for information extraction. For example, some embodiments of the teachings herein include a computer-implemented method for enhancing reliability of bootstrapping for information extraction, IE, comprising: performing (S10) relation extraction, RE, to acquire a seed instance including a pair of entities and relationship information between the pair of entities; finding (S20) seed occurrences which match to the seed instance in a document collection; generating (S30) a set of extraction patterns corresponding to the relationship information by clustering the seed occurrences, wherein each of the extraction patterns is mapped to one of clusters of the seed occurrences; generating (S40) a graph which represents similarity between the extraction patterns based on word embedding vectors for each of the extraction patterns; identifying (S50) at least one noisy extraction pattern among the set of the extraction patterns based on the similarity and a pre-defined threshold; and rectifying (S60) the set of extraction patterns by removing the identified noisy extraction pattern from the graph.

In some embodiments, the word embedding vectors for each extraction pattern are generated based on a sum of results of embedding all words before the pair of entities, between the pair of entities, and/or after the pair of entities of seed occurrences included in a corresponding cluster in the document collection.

In some embodiments, the graph is a spanning tree including the extraction patterns connected by edges which does not configure a closed loop.

In some embodiments, a length of each edge in the spanning tree is proportional to a similarity value of two extraction patterns which are connected by said edge.

In some embodiments, identifying (S50) includes: if an extraction pattern has a similarity value to a neighbor extraction pattern connected to the extraction pattern which is below the pre-defined threshold, deciding that the extraction pattern is a noisy extraction pattern.

In some embodiments, identifying (S50) includes: if an extraction pattern has an average of similarity values to at least two neighbor extraction patterns connected to the extraction pattern which is below the pre-defined threshold, deciding that the extraction pattern is a noisy extraction pattern.

In some embodiments, identifying (S50) includes: if an extraction pattern has a maximum of similarity value to neighbor extraction patterns connected to the extraction pattern which is below the pre-defined threshold, deciding that the extraction pattern is a noisy extraction pattern.

In some embodiments, identifying (S50) further includes: if the extraction pattern has a maximum of similarity value to a neighbor extraction pattern which is above the pre-defined threshold, and if the extraction pattern has a similarity value to a neighbor extraction pattern which is below the pre-defined threshold, removing an edge corresponding to the similarity value below the pre-defined threshold.

In some embodiments, the method further comprises: comparing (S70) a candidate instance corresponding to a specific extraction pattern included in the rectified set with a word, which is predicted by a language model, LM, based on a portion of the candidate instance; and determining (S80) that the specific extraction pattern has same semantics as the relationship information of the seed instance in case the word predicted by the LM matches to another portion of the candidate instance.

In some embodiments, the word predicted by LM is at least one of: a first entity of the candidate instance, a second entity of the candidate instance, and/or the specific extraction pattern corresponding to the candidate instance.

In some embodiments, determining (S80) includes deciding that the word predicted by the LM matches to another portion of the candidate instance in case a type of the word predicted by the LM is identical to a type of another portion of the candidate instance.

In some embodiments, the LM is pre-trained by unstructured corpora such that the LM is equipped with a function of predicting the word based on the portion of the candidate instance.

As another example, some embodiments include an apparatus (100) configured to perform one or more of the methods described herein.

As another example, some embodiments include a computer program product (300) comprising executable program (350) code configured to, when executed, perform one or more of the methods described herein.

As another example, some embodiments include a non-transitory computer-readable data storage medium (400) comprising executable program code (450) configured to, when executed, perform one or more of the methods described herein.

### BRIEF DESCRIPTION OF THE DRAWINGS

The teachings of the present disclosure will be explained in yet greater detail with reference to exemplary embodiments depicted in the drawings as appended. The accompanying drawings are included to provide a further understanding of the present disclosure and are incorporated in and constitute a part of the specification. The drawings illustrate various embodiments and together with the description serve to illustrate the principles of the teachings herein. Other embodiments and many of the intended advantages will be readily appreciated as they become better understood by reference to the following detailed description. Like reference numerals designate corresponding similar parts.

The numbering of method steps is intended to facilitate understanding and should not be construed, unless explicitly stated otherwise, or implicitly clear, to mean that the designated steps have to be performed according to the numbering of their reference signs. In particular, several or even all of the method steps may be performed simultaneously, in an overlapping way or sequentially.

FIG. 1 shows a schematic flow diagram illustrating a computer-implemented method incorporating teachings of the present disclosure;

FIG. 2 shows a schematic flow diagram illustrating a computer-implemented method incorporating teachings of the present disclosure;

FIG. 3 shows a schematic flow diagram illustrating a computer-implemented method incorporating teachings of the present disclosure;

FIG. 4, FIG. 5 and FIG. 6 schematically illustrate further details of the method according to FIG. 1;

FIG. 7 shows a schematic flow diagram illustrating a computer-implemented method incorporating teachings of the present disclosure;

FIG. 8 shows a block diagram schematically illustrating an apparatus incorporating teachings of the present disclosure;

FIG. 9 shows a block diagram schematically illustrating a computer program product incorporating teachings of the present disclosure; and

FIG. 10 shows a block diagram schematically illustrating a data storage medium incorporating teachings of the present disclosure.

### DETAILED DESCRIPTION

Some embodiments of the teachings herein include a computer-implemented method for enhancing reliability of bootstrapping for information extraction, IE, comprising: performing relation extraction, RE, to acquire a seed instance including a pair of entities and relationship information between the pair of entities; finding seed occurrences which match to the seed instance in a document collection; generating a set of extraction patterns corresponding to the relationship information by clustering the seed occurrences, wherein each of the extraction patterns is mapped to one of clusters of the seed occurrences; generating a graph which represents similarity between the extraction patterns based on word embedding vectors for each of the extraction patterns; identifying at least one noisy extraction pattern among the set of the extraction patterns based on the similarity and a pre-defined threshold; and rectifying the set of extraction patterns by removing the identified noisy extraction pattern from the graph.

In some embodiments, the word embedding vectors for each extraction pattern are generated based on a sum of results of embedding all words before the pair of entities, between the pair of entities, and/or after the pair of entities of seed occurrences included in a corresponding cluster in the document collection.

In some embodiments, the graph is a spanning tree including the extraction patterns connected by edges which does not configure a closed loop.

In some embodiments, a length of each edge in the spanning tree is proportional to a similarity value of two extraction patterns which are connected by said edge.

In some embodiments, the step of identifying includes, if an extraction pattern has a similarity value to a neighbor extraction pattern connected to the extraction pattern which is below the pre-defined threshold, deciding that the extraction pattern is a noisy extraction pattern. In this way, only the extraction patterns with strong similarities or correlations remain so that semantic drift by, for example, a chain of only loosely similar patterns is avoided. For example, in some context, “A bought B” means (in colloquial language) that “A believes a lie B that was told to A” instead of “A acquired B”. In turn, to this meaning “A believed B” would be similar. So the bootstrapping might find similarities between “A acquired B” and “A bought B”, and then from “A bought B” to “A believed B” and so on, as an example for semantic drift. However, since the meaning “A acquired B” for “A bought B” is much more common than “A believed B”, the similarity value would be low and the semantic drift can be prevented by identifying “A believed B” as a noisy pattern.

In some embodiments, identifying includes, if an extraction pattern has an average of similarity values to at least two neighbor extraction patterns connected to the extraction pattern which is below the pre-defined threshold, deciding that the extraction pattern is a noisy extraction pattern. In this way, again, only extraction patterns with generally high similarities to other extraction patterns remain. Similarly to above, this prevents semantic drift by isolated (semantic) chains of loosely similar patterns. In this way, again, only extraction patterns with generally high similarities to other extraction patterns remain. Similarly to above, this prevents semantic drift by isolated (semantic) chains of loosely similar patterns.

In some embodiments, identifying includes, if an extraction pattern has a maximum of similarity value to neighbor extraction patterns connected to the extraction pattern which is below the pre-defined threshold, deciding that the extraction pattern is a noisy extraction pattern. The noisy extraction patterns may be pruned (i.e. removed) from the graph.

In some embodiments, identifying further includes, if the extraction pattern has a maximum of similarity value to a neighbor extraction pattern which is above the pre-defined threshold, and if the extraction pattern has a similarity value to a neighbor extraction pattern which is below the pre-defined threshold, removing an edge corresponding to the similarity value below the pre-defined threshold.

In some embodiments, the method further comprises: comparing a candidate instance corresponding to a specific extraction pattern included in the rectified set with a word, which is predicted by a language model, LM, based on a portion of the candidate instance; and determining that the specific extraction pattern has same semantics as the relationship information of the seed instance in case the word predicted by the LM matches to another portion of the candidate instance.

In some embodiments, the word predicted by LM is at least one of: a first entity of the candidate instance, a second entity of the candidate instance, and/or the specific extraction pattern corresponding to the candidate instance.

In some embodiments, determining includes deciding that the word predicted by the language model, LM, matches to another portion of the candidate instance in case a type of the word predicted by the LM is identical to a type of another portion of the candidate instance. The type of word (i.e. a word predicted by LM or another portion of the candidate instance) may be a category including a plurality of words. That is, the type may be a superordinate concept which includes a certain category of words. The type may be defined based on meanings of the words.

For example, the type of words may be a product, an organization, technology, etc.

In some embodiments, the language model, LM, is pre-trained by unstructured corpora such that the LM is equipped with a function of predicting the word based on the portion of the candidate instance.

The teachings herein also include apparatuses configured to perform one or more of the methods described herein. The apparatus may comprise an input interface, a computing device and an output interface.

The computing device may be realized in hardware, such as a circuit or a printed circuit board and/or comprising transistors, logic gates and other circuitry. Additionally, the computing device may be at least partially realized in terms of software. Accordingly, the computing device may comprise, or be operatively coupled to, a processor (one or more CPUs and/or one or more GPUs and/or one or more ASICs and/or one or more FPGAs), a working memory and a non-transitory memory storing a software or a firmware that is executed by the processor to perform the functions of the computing device. Signals may be received by the input interface and signals that the processor of the computing device creates may be outputted by the output interface. The computing device may be implemented, at least partially, as a microcontroller, an ASIC, an FPGA and so on.

Some embodiments include a non-transitory computer-readable data storage medium comprising executable program code configured to, when executed by a computing device, perform one or more of the methods described herein.

Some embodiments include a computer program product comprising executable program code configured to, when executed by a computing device, perform one or more of the methods described herein.

Some embodiments include a data stream comprising, or configured to generate, executable program code configured to, when executed by a computing device, perform one or more of the methods described herein.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

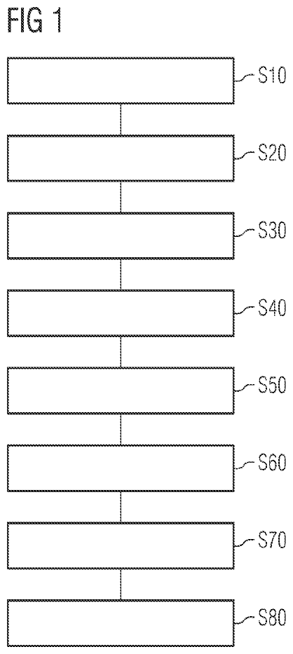

FIG. 1 shows a schematic flow diagram illustrating a computer-implemented method incorporating teachings of the present disclosure, i.e. a computer-implemented method for enhancing reliability of bootstrapping for information extraction. The method will be described using the English language for examples. However, it will be evident that the same method may be applied to any other language as well, for example to Chinese, Hindustani, Spanish, Arabic, Malay, Russian, Bengali, Portuguese, French, German, Japanese, and so on.

In step S10, a relation extraction, RE, is performed to acquire a seed instance. The RE transforms unstructured text into relational triples, each representing a relationship between two named-entities. That is, RE acquires a seed instance which includes a pair of entities, and relationship information between the pair of entities. An entity in this sense may be, for example, one of a person, organization, location of the organization, products, technologies, etc. One of the pair of entities may be a subject, and the other of the pair of entities may be an object. In this disclosure, the entity may be also referred to as a nominal. The relationship information may be a relationship between pairs of nominals or entities, such as supplier-of, acquired-by, etc. In the present disclosure, the relationship information may be also referred to as relation, relationship, relation-pattern or relation-expression. RE may attempt to find similar relationships using word embedding.

In step S20, seed occurrences which match to the seed instance are searched and found in a document collection. The seed occurrences may be also referred to as seed match or occurrences contexts. The seed occurrence may be regarded as being matched to the seed instance when the seed occurrence includes a pair of entities of the seed instance.

More specifically, the document collection may be scanned and, if the pair of entities of the seed instance co-occurs in a text segment within a sentence, then that text segment may be configured into three textual contexts which are extracted as: words before the first entity (BEF), words between the two entities (BET), and words after the second entity (AFT). A new instance extracted from a sentence that includes seed occurrence may be referred to as relationship instance. Thus, a specific relationship instance matches to a specific seed occurrence.

As describe above, a relationship instance i is represented by three embedding vectors: V_{BEF}, V_{BET}, and V_{AFT}.

Considering the sentence:
The tech company Soundcloud is based in Berlin, capital of Germany.

The relationship instance i may be generated with:
V_{BEF}=E(“tech”)+E(“company”)
V_{BET}=E(“is”)+E(“based”)
V_{AFT}=E(“capital”)

where, E(x) is the word embedding for word x.

In this disclosure, the document collection may be a set of documents included in large-scale unstructured industrial corpora and/or web. The documents may be a combination of texts from different corpora and/or web.

In step S30, a set of extraction patterns is generated. A set of extraction patterns corresponds to the relationship information of seed instance. The set of extraction patterns may include various expressions which has identical (or similar) semantics to the relationship information of seed instance. However, in this step, the set of extraction patterns may also include at least one other expression which does not belong to identical (or similar) semantic category of the relationship information of seed instance. This other expression may be referred to as noisy extraction pattern as described below. Thus, the set of extraction patterns corresponding to the relationship information may be a set of candidate extraction patterns to be regarded as identical (or similar) to the relationship information of seed instance.

A set of extraction patterns is generated by clustering the seed occurrences. The seed occurrences may be clustered into a plurality of clusters. The clustering seed occurrences may be performed based on relationship instances which are extracted from each of seed occurrences. As described above, each of relationship instances may be extracted from a seed occurrence. That is, a specific relationship instance may correspond to a specific seed occurrence.

The clustering may be performed by a single-pass clustering algorithm. The single-pass clustering algorithm takes as input a list of relationship instances and assigns the first relationship instance to a new empty cluster. Next, the single-pass clustering algorithm iterates through the list of relationship instances, computing the similarity between an instance iₙ and every cluster Clⱼ. The relationship instance iₙ is assigned to the first cluster whose similarity is higher or equal to a threshold τₛᵢₘ. If all the clusters have a similarity lower than a threshold τₛᵢₘ, a new cluster Cₘ is created, containing the relationship instance iₙ. The similarity function Sim(iₙ, Clⱼ), between an instance iₙ and a cluster Clⱼ, returns the maximum of the similarities between a relationship instance iₙ and any of the relationship instances iₙ a cluster Clⱼ, if the majority of the similarity scores is higher than a threshold τₛᵢₘ. A value of zero is returned otherwise.

Each of extraction patterns is mapped to one of clusters of seed occurrences. Each of extraction patterns are represented by respective word embedding vectors. The word embedding vectors for each of extraction patterns are generated based on a sum of embedding of all words in before, BEF, a pair of entities, between, BET, the pair of entities, or after, AFT, the pair of entities of seed occurrences which form a cluster mapped to said extraction pattern in the document collection. Alternatively, the word embedding vector of an extraction pattern is generated by averaging the sum of word embedding in BEF, BTW and/or AFT for all seed occurrences which form a specific cluster corresponding to the extraction pattern. In other words, for each of the extraction patterns, a representation (word embedding vector) may be generated by averaging and/or summing embeddings of all words in BEF, BET or AFT context with/without removing stopwords for each of the relationship instances included a cluster.

In some embodiments, extraction patterns may be generated based on clustering relationship instances, such that each cluster may contain a set of relationship instances. Also, the extraction pattern may be represented by a centroid of the vectors that form a cluster.

In step S40, a graph which represents similarity between the extraction patterns is generated. The graph is generated based on word embedding vectors for each of the extraction patterns. In this graph, each node represents one of the extraction patterns, and each edge connecting two of extraction patterns represents similarity of the connected two extraction patterns. In some embodiments, a length of each edge is proportional to the similarity value of two extraction patterns connected by the corresponding edge. The graph may include extraction patterns represented by nodes, and extraction patterns are connected by a plurality of edges which does not configure a closed loop.

In some embodiments, the graph may be a spanning tree. The spanning tree is a connected undirected graph with no cycles. It is a spanning tree of a graph G if it spans G (that is, it includes every vertex of G) and is a subgraph of G (every edge in the tree belongs to G). A spanning tree of a connected graph G may also be defined as a maximal set of edges of G that contains no cycle, or as a minimal set of edges that connect all vertices. The spanning tree may be computed based on Kruskal's algorithm. The Kruskal's algorithm is a greedy algorithm of graph theory for computing the spanning trees of undirected graphs. The graph is also connected, edge-weighted and finite. An undirected graph G may be computed, where each node u represents an extraction pattern, while the edge (u, v) is weighted by similarity between extraction patterns u and v. Then it may compute the spanning tree of the graph G based on the similarity weights.

In step S50, at least one noisy extraction pattern among the set of the extraction pattern is identified. “Noisy extraction pattern” here means in particular an extraction pattern which does not belong to a same (or similar) semantic class of relationship information of the seed instance. The noisy extraction pattern is identified based on the similarity between the extraction patterns and a pre-determined threshold.

In some embodiments, if a specific extraction pattern has a similarity value to a neighbor extraction pattern connected to the specific extraction pattern which is below the pre-defined threshold, it is determined that the specific extraction pattern is the noisy pattern. The specific extraction pattern may be deleted.

In some embodiments, if a specific extraction pattern has an average of similarity values to at least two neighbor extraction patterns connected to the specific extraction pattern which is below the pre-defined threshold, it is determined that the specific extraction pattern is the noisy pattern. The specific extraction pattern may be deleted.

In some embodiments, if a specific extraction pattern has a maximum of similarity value to at least two neighbor extraction patterns connected to the specific extraction pattern which is below the pre-defined threshold, it is determined that the specific extraction pattern is the noisy pattern. The specific extraction pattern may be deleted. In this embodiment, if a specific extraction pattern has a maximum of similarity value to at least two neighbor extraction patterns connected to the specific extraction pattern which is above the pre-defined threshold, and the specific extraction pattern has a similarity value to a neighbor extraction pattern connected to the specific extraction pattern which is below the pre-defined threshold, an edge corresponding to the similarity value below the pre-defined threshold is removed.

In step S60, the set of extraction patterns is rectified by removing the identified noisy extraction pattern. The noisy extraction pattern may be deleted from the graph. Meanwhile, algorithm 1 and 2 describes extraction pattern rectifying procedure. In this disclosure, the rectifying procedure may be referred to as a pruning procedure. The motivation is to identify noisy-high-confidence (NHC) extraction patterns, e.g. noisy extraction patterns, and prune them via odd-one-out puzzle style to control and minimize semantic drift. The basic idea is to compute the density of each node and filter-out/prune the node(s) from the spanning tree that are not dense ‘enough’, like anomaly detection or odd-one-out selection approach. In the present disclosure, the extraction pattern pruning procedure may consist of steps S40, S50 and S60.

[Algorithm 1]

NHC Patterns Detection

Input: Λ
1: Compute representation of each of the high confidence patterns
by averaging all words (of BET context) of the instance(s) within
each pattern
Λ_{emb} = {avgemb(λ)|λ ϵ Λ \hat{ } λ_{conf} >= τ_{conf}}
2: Construct a complete graph G (pattern graph), where the nodes
are patterns and edges are weighted with similarity scores.
G(u, v) = completeGraph (Λ_{emb})
3: Construct the maximum spanning tree (MST) using Kruskal's
algorithm.
G_{MST} = findSpanningTree (G, Kruskal)
4: Prune nodes in the MST
Gₚ = pruneMST (G_{MST}, τₚᵣᵤₙ, strategy)
5: return pattern (s) in the graph after pruning.
return {λ|λ ϵ Gₚ}

[Algorithm 2]

```
Prune Nodes in MST
  Input: G_{MST}, τₚᵣᵤₙ
  Input: strategy={pruneLeaf, pruneNodeAvg, pruneNodeMin}
function NORM {G}
  for u, v ∈ G.edges( ) do
    $G [ u ] [ v ] = 1 - \frac{maxWeight - G [ u ] [ v ]}{maxWeight}$
  Return G
function PRUNEMST (G_{MST}, τₚᵣᵤₙ, strategy)
  G= norm(G_{MST})
  for u ∈ G.nodes( ) do
    if pruneLeaf and degree(u) = 1 then
      if u ∈ G.nodes( ) then
        G. deleteNode(u)
    if pruneNodeAvg then
      if avg(G[u][: ]) <= τₚᵣᵤₙ then
        G. deleteNode(u)
if pruneNodeMin then
      if max(G[u][: ]) <= τₚᵣᵤₙ then
        G. deleteNode(u)
      else
        for v ∈ G.nodes( ) and v ≠ u do
          if G[u][v] <= τₚᵣᵤₙ then
  G. deleteEdge(u, v)
return G
```

Following is example of strategies to prune/select at least one of the noisy extraction pattern(s):
Strategy=pruneLeaf: Find the least edgedweighted leaf node, and prune it if the weight is below the certain pruning threshold, τprun.
Strategy=pruneNodeAvg: Compute node density by avgpweights1:Cq, where is C is the number of edges n is connected to. Prune the node n, if the average score is below τprun.
Strategy=pruneNodeMin: Delete all edges connected to u for which edge weights are below τprun.

The strategies described above may be not only taken alone, but also taken in combination.

In some embodiments, the bootstrapping may be performed based on combination of steps S10-S60. In this case, determination of whether an extraction pattern has a same semantics as the relationship information of seed instance may be performed based on the rectified set of extraction patterns. In other words, if an extraction pattern is still remained in the graph after rectifying the set of extraction pattern, the extraction pattern may be considered as same semantic of relationship information of seed instance. Or, extraction patterns included in rectified set may be regarded as same semantic of relation information of seed instance.

In some embodiments, further procedures may be performed for determination procedure to determine whether an extraction pattern has a same semantics as the relationship information of seed instance. Hereinafter, the optional procedures are described.

In step S70, a candidate instance corresponding to a specific extraction pattern included in the rectified set is compared with a word predicted by a language model, LM, based on a portion of the candidate instance. The candidate instance means an instance that is found on document collection based on extraction pattern. The candidate instance may be configured in form of triple, e.g. subject, relationship information and object, and the relationship information. The relationship information included in the candidate instance may correspond to an extraction pattern.

The rectified set may be a set of extraction pattern with extraction pattern pruning procedure. Thus, noisy extraction pattern is not included in the rectified set of extraction patterns. The LM in the present disclosure is pre-trained by unstructured corpora such that the LM is equipped with a function of predicting the word based on the portion of the candidate instance.

In some embodiments, the LM may predict a word based on a sentence including a portion of the candidate instance. The portion of the candidate instance means a candidate instance with a missing element. The missing element may be related to at least one of the pair of entities or relationship information. That is, the sentence may have a missing word, so that the LM predicts the missing word based on the rest of the words in the sentence. Thus, the missing word, e.g. the predicted word may be at least one word included in one of the pair of entities or relation information between the pair of entities.

In some embodiments, the LM may be Bidirectional Encoder Representations from Transformers (BERT), which is a technique for NLP (Natural Language Processing) pre-training developed by Google. Also, the LM may be RoBERT language model enhanced based on BERT. However, Lm in the present disclosure is not limited to a specific model.

In step S80, it is determined that the specific extraction pattern has the same semantics as the relationship information of the seed instance in case the predicted word by the LM matches to another portion of the candidate instance. Another portion of the candidate instance may be the missing element of the candidate instance. It is determined that the predicted word matches to another portion of the candidate instance, when a type of the predicted word is identical to a type of another portion of the candidate instance. The type may be one of the types of entities included in instances. The type of words (a word predicted by LM or a missing element) may be a category including a plurality of words. That is, the type may be a superordinate concept which includes a certain category of words. The type may be defined based on meanings of the words. For example, the type of words may be a product, an organization, technology, etc.

Meanwhile, the steps S70 and S80 described above may be referred to as a verifying procedure. In verifying whether a candidate instance belong to same semantic class to the seed instance, a large-scale pre-trained language model as knowledge bases may be used since they have abilities to encode unstructured information as factual knowledge.

The verifying procedure may determine if the factual knowledge encoded in a candidate instance aligns with factual knowledge encoded in the LMs pre-trained on large unstructured corpora. Each fact has five components: subject-type, subject, relation-pattern, object-type and object. The verifying procedure may be performed based on the five components.

Following strategies may be used for verifying candidate instances, as taken alone or in combination.
Factifying subject-object types: Check if the object-type of a candidate instance match with the type of ‘fill-in-the-MASK’ value predicted by the language model (e.g., BERT). If match, then the instance is non-noisy.
Factifying object mentions: Check if the object of a candidate instance match with the ‘fill-in-the-MASK’ value predicted by the language model (e.g., BERT). If match, then the instance is non-noisy.
Factifying relation-pattern: Check if the relation-expression of a candidate instance match with the ‘fill-in-the-MASK’ value predicted by the language model (e.g., BERT). If match, then the instance is non-noisy.

In some embodiments, a semantic drift problems in bootstrapping relation extraction may be minimized and therefore, precise knowledge without human-in-the-loop can be extracted efficiently. Also, human efforts in guiding machine learning systems may be reduced, data annotation time and budget may be saved. Also, data annotations are not required. It is a very-weakly supervised system to precisely extract relations. Also, it may be optimized for supply-chain services by precisely extracting relevant information/knowledge about suppliers, profiling suppliers, risk involved, technologies supplied, etc. Given that a consumer company recognizes a failure of the supplier in a good time, the consumer can switch to another supplier in order to save costs. Experts believe that the production and logistics costs can be reduced by 5 to 10 percent.

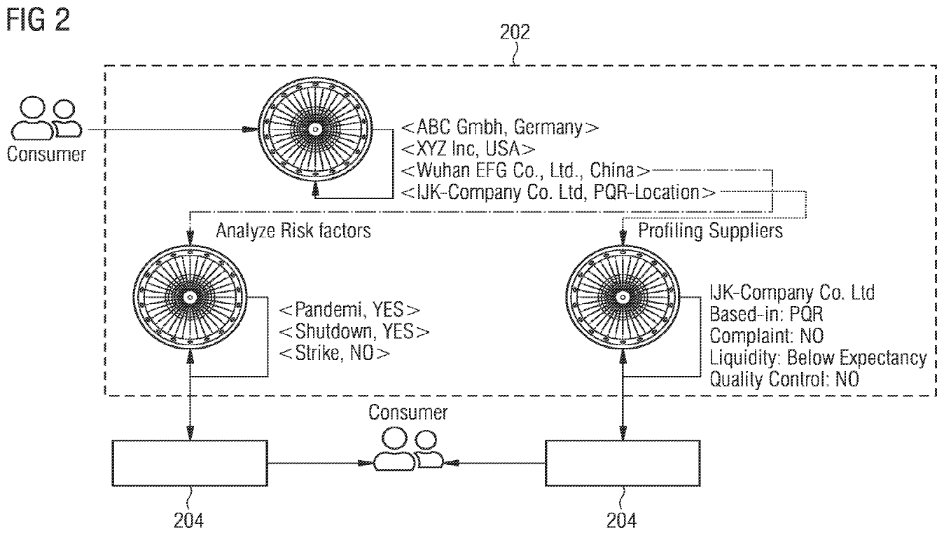

FIG. 2 shows an example of procedures performed by information extraction engine 202. The information extraction engine 202 may be configured to perform relation extraction, RE. Moreover, the information extraction engine 202 may be configured to perform bootstrapping relationships. Therefore, the information extraction engine 202 may precisely extract relevant information from a query in form of triples that are used to populate and build industrial knowledge graph.

The information extraction engine 202 may be used for, for example, automatic analysis of supply chain management services, automatic fault diagnosis and monitoring system in turbine and industrial equipments by analyzing service reports, or automatic industrial knowledge graph construction. The extracted information is further used in predictive maintenance and business intelligence.

In some embodiments, a customer inputs at least one query. The query may be used to extract relevant information hidden in industrial corpora or www(internet). In FIG. 2, two queries may be provided by the consumer. A first query may be ‘Who are the best suppliers of Thermocouples Technology?’, and a second query may be ‘What are the risks for technologies supplied/manufactured by the supplier?’. The first query may be considered as including a first entity, i.e. Thermocouples Technology, and relationship information, i.e. supplier-of. The second query may be considered as including a first entity, i.e. ‘technologies supplied/manufactured by the supplier’, and relationship information, i.e. risk.

First, the information extraction engine 202 may search for list of suppliers. For example, the suppliers may be ABC Gmbh, XYZ Inc, Wuhan EFG Co. Ltd, IJK Company Co. Ltd, etc. Second, the information extraction engine 202 may organize a seed instance in form of triple, e.g. a first entity, a second entity, and relationship information between the first entity and the second entity.

The information extraction engine 202 may perform bootstrapping to extract all fact in form of triple (e.g. subject, relationship, object) for a specific relationship using seed instance. This procedure according to the present disclosure provides enhancement of the bootstrapping.

In FIG. 2, regarding the first query, a semantic of relationship ‘best supplier-of’ may be extended to ‘based in’, ‘complaint’, ‘Liquidity’, ‘Quality control’, etc. Thus, the information extraction engine may search for information corresponding to the extended semantic relationship. For example, the information may include ‘Based-in’, ‘complaint’, ‘Liquidity’, ‘Quality control’ for supplier ‘IJK-Company Co. Ltd’.

Also, regarding second query, a semantic of relationship ‘risk’ may be extended to ‘Pandemic’, ‘Shutdown’, ‘Strike’, etc. Thus, the information extraction engine may search for information corresponding to the extended semantic relationship. For example, the information may include ‘Pandemic’, ‘Shutdown’, ‘Strike’ for supplier ‘Wuhan EFG Co., Ltd’.

The extracted information may be forwarded to monitoring system 204. The monitoring system 204 may suggest a business decision based on the forwarded information.

In some embodiments, with the extracted information in response to the first query, the monitoring system 204 may suggest the customer to switch supplier. More specifically, the monitoring system 204 may suggest business decisions based on the extracted information which represents that the supplier has ‘below Expectancy’ for extended semantic relationship ‘Complaint’, and ‘No’ for extended semantic relationship ‘Quality Control’.

In some embodiments, with the extracted information in response to the second query, the monitoring system 204 may suggest the customer to switch supplier. Further, monitoring system 204 may propose to deprecate including the supplier into supply-chain. More specifically, the monitoring system 204 may suggest business decisions based on extracted information which represents that the supplier has ‘Yes’ for extended semantic relationship ‘Pendemic’, and ‘Yes’ for extended semantic relationship ‘Shutdown’.

In this manner, the customer make business decision efficiently in various field based on automatically extracted precise information. Furthermore, the cost for production or logistics may be reduced with help of the information extraction engine 202. Although the information extraction engine 202 and the monitoring system 204 are illustrated as separated device, but the monitoring system 204 may be also included in information extraction engine 204.

In some embodiments, at least one following advantage may be achieved:
It may minimize semantic drift problems in bootstrapping relation extraction and therefore, extract precise knowledge without human-in-the-loop efficiently.
It may reduce human efforts in guiding machine learning systems and therefore, save data annotation time and budget.
It may not require data annotations. It is a very-weakly supervised system to precisely extract relations.
It may optimize supply-chain services by precisely extracting relevant information/knowledge about suppliers, profiling suppliers, risk involved, technologies supplied, etc. Given that a consumer company recognizes a failure of the supplier in a good time, the consumer can switch to another supplier in order to save costs. Experts believe that the production and logistics costs can be reduced by 5 to 10 percent.

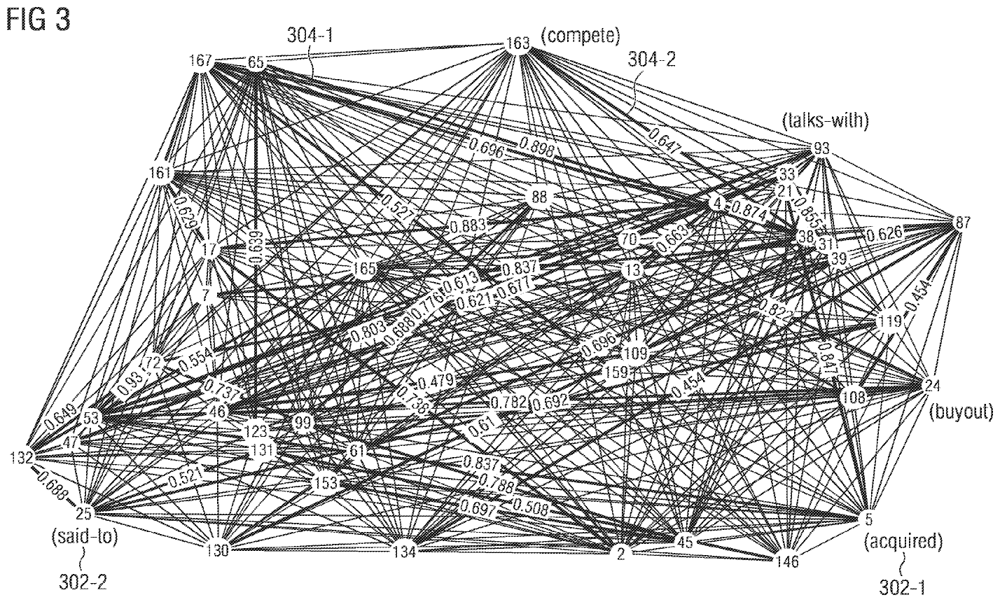

FIG. 3 shows an example of spanning tree. In FIG. 3, the spanning tree includes a plurality of nodes 302-1, 302-2, a plurality of edges 304-1, 304-2. Each of the nodes 302-1, 302-2 represents corresponding extraction pattern, for example, acquired, buyout, talks-with, compete, said-to, etc. Each of edges 304-1, 304-2 represents similarity between connected nodes. For example, a length of each edge 304-1, 304-2 may be proportional to the similarity values between connected nodes. In this example, there are 167 nodes in total, while 40 nodes with confidence above 0.70. Here, a complete graph, G has been computed based on those 40 nodes.

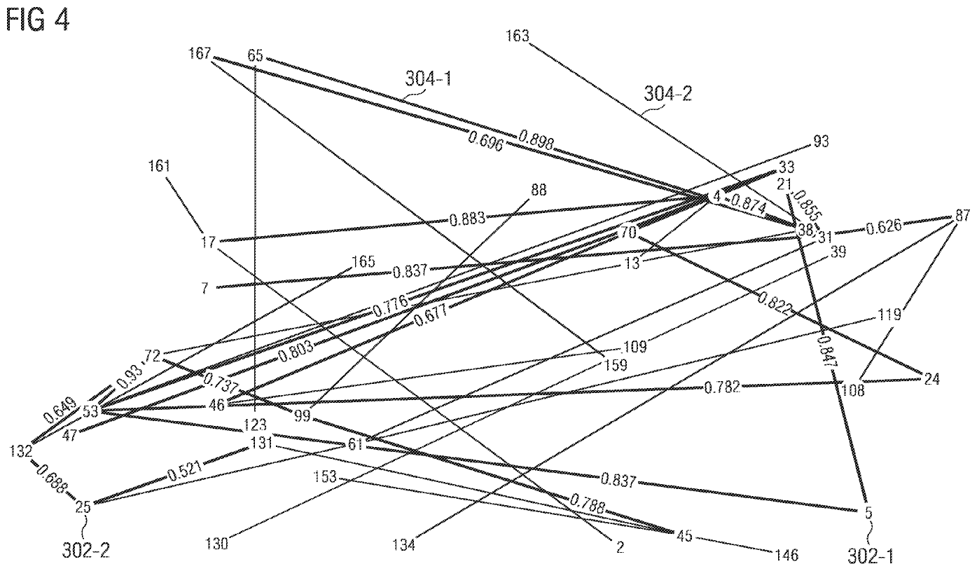

FIG. 4 to FIG. 6 shows an example of rectifying extraction patterns on the spanning tree. FIG. 4 shows an example of rectifying extraction patterns on the spanning tree under condition of ‘node degree=1’. The node degree indicates the number of edges connecting to neighbor nodes. In FIG. 4, the nodes whose node degree equal to 1 may be deleted. The deleted edges are illustrated as normal edges, whereas the remained edges are illustrated as highlighted edges. Therefore, the highlighted edges indicate existing connections between nodes after pruning and the nodes in the pruned graph suggests the non-noisy patterns. In this example, the node 302-1 and node 302-2 are still remained with connected edges. Also, the edge 304-1 is still remained in the spanning tree, and the edge 304-2 has been removed.

FIG. 5 shows an example of rectifying extraction patterns on the spanning tree under condition of ‘nodes degree=2’ and ‘Strategy=pruneNodeMin’. That is, an edge with minimum similarity value for a node whose node degree equals to 2 may be further deleted. In FIG. 5, the highlighted edges indicate existing connections between nodes after pruning and the nodes in the pruned graph suggests the non-noisy patterns. In this example, the node 302-1 and node 302-2 are still remained with connected edges. Also, the edge 304-1 is still remained in the spanning tree.

FIG. 6 shows an example of rectifying extraction patterns on the spanning tree under condition of ‘nodes degree≥1’ and ‘Strategy=pruneNodeMin’. That is, an edge with minimum similarity value for a node whose node degree equals to (or above) 1 may be deleted. In FIG. 6, the highlighted edges indicate existing connections between nodes after pruning and the nodes in the pruned graph suggests the non-noisy patterns. In this example, the node 302-1 is still remained and node 302-2 is removed. Also, the edge 304-1 is still remained in the spanning tree. More specifically, as shown in FIG. 6, it may be observed that there are 22 noisy extraction patterns out of 40. The noisy extraction patterns (IDs) are: [13, 25, 38, 45, 61, 65, 87, 88, 93, 99, 108, 123, 130, 131, 132, 134, 146, 153, 159, 161, 163, 165, 167]. The noisy extraction pattern may be detected by pruning the nodes without highlighted edges, and the dense nodes remain in the pruned graph, suggesting the non-noisy extraction patterns.

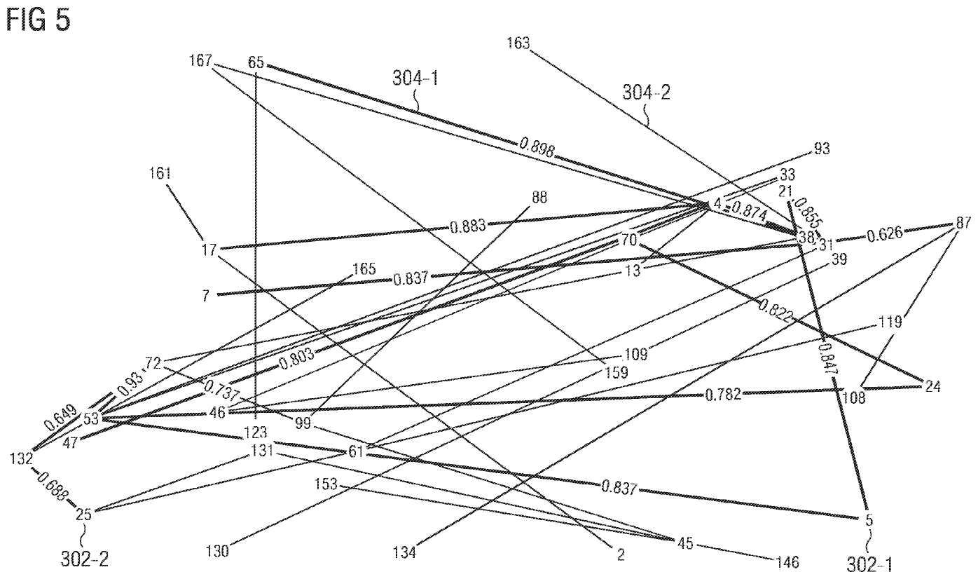

FIG. 7 shows examples of verifying strategies using pre-trained language models. For verifying strategies, a sentence corresponding to a candidate instance in form of triple (subject, relation-pattern, object) may be used. The sentence may include the subject, relation-pattern and object of the candidate instance. In this example, the subject is Siemens, the relation-pattern is ‘manufactures’, and the object is ‘gas turbines’. The verifying procedure may be performed based on five components, e.g. subject-type, subject, relation-pattern, object-type and object. The type may be one of the types of entities included in instances. The type of words (a word predicted by LM or a missing element) may be a category including a plurality of words. That is, the type may be a superordinate concept which includes a certain category of words. The type may be defined based on meanings of the words. For example, the type of words may be a product, an organization, technology, etc.

The sentence in this example may be ‘Siemens manufactures gas turbines’. The sentence may be processed to include a mask on one of the words. The language model, LM, may perform a task which requires to fill the mask value. The predicted word by LM may be referred to as ‘fill-in-the-MASK’ value.

In the present disclosure, the LM may be Bidirectional Encoder Representations from Transformers (BERT), which is a technique for NLP (Natural Language Processing) pre-training developed by Google. Or, the LM may be RoBERT language model enhanced based on BERT.

In a first example, the processed sentence may be ‘Siemens manufactures gas [MASK]’. The fill-in-the-Mask value by LM may be ‘turbines’, ‘engines’ and ‘station’. It may be checked if the object type of the candidate instance matches with the type of ‘fill-in-the-MASK’ value. If it matches, then it is determined that the candidate instance is not noisy. Furthermore, it may be checked if the object of the candidate instance match with the ‘fill-in-the-MASK’ value predicted by LM. If it matches, then it is determined that the candidate instance is not noisy. Non-noisy means that the specific extraction pattern corresponding the candidate instance has the same semantics as the relationship information of the seed instance.

In a second example, the processed sentence may be ‘Siemens [MASK] gas turbines’. The fill-in-the-Mask value by LM may be ‘designed’, ‘produces’, ‘integrated’ and ‘manufactures’. It may be checked if the object type of the relation-expression of a candidate instance matches with the ‘fill-in-the-MASK’ value predicted by the LM. If it matches, the candidate instance is non-noisy.

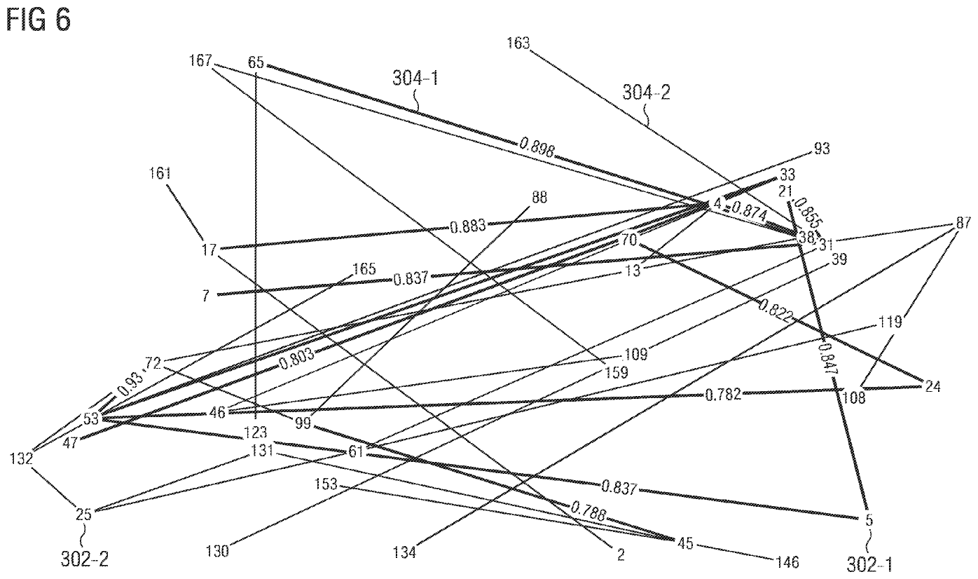

FIG. 8 shows an apparatus 100 incorporating teachings of the present disclosure, i.e. an apparatus for enhancing reliability of bootstrapping for information extraction. In particular, the apparatus 100 is configured to perform one or more of the methods as described herein, in particular the method as described in the foregoing with respect to FIG. 1 through FIG. 7. The apparatus 100 comprises an input interface 110 for receiving an input signal 71, wherein the task is to performing the bootstrapping. The input interface 100 may be realized in hard- and/or software and may utilize wireless or wire-bound communication. For example, the input interface 110 may comprise an Ethernet adapter, an antenna, a glass fiber cable, a radio transceiver and/or the like.

The apparatus 100 further comprises a computing device 120 configured to perform the steps S10 through S80. The computing device 120 may in particular comprise one or more central processing units, CPUs, one or more graphics processing units, GPUs, one or more field-programmable gate arrays FPGAs, one or more application-specific integrated circuits, ASICs, and or the like for executing program code. The computing device 120 may also comprise a non-transitory data storage unit for storing program code and/or inputs and/or outputs as well as a working memory, e.g. RAM, and interfaces between its different components and modules.

In some embodiments, the apparatus may further comprise an output interface 140 configured to output an output signal 72, for example as has been described with respect to step S90 in the foregoing. The output signal 72 may have the form of an electronic signal, as a control signal for a display device 200 for displaying the semantic relationship visually, as a control signal for an audio device for indicating the determined semantic relationship as audio and/or the like. Such a display device 200, audio device or any other output device may also be integrated into the apparatus 100 itself.

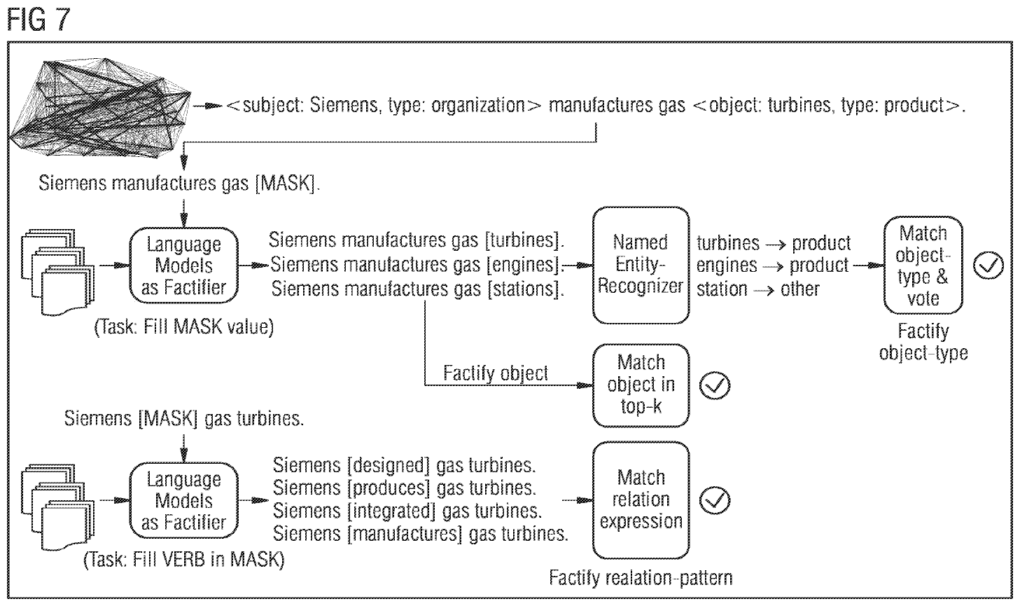

FIG. 9 shows a schematic block diagram illustrating a computer program product 300 incorporating teachings of the present disclosure, i.e. a computer program product 300 comprising executable program code 350 configured to, when executed (e.g. by the apparatus 100), perform one or more of the methods as described herein, in particular the method as has been described with respect to FIG. 1 through FIG. 7 in the foregoing.

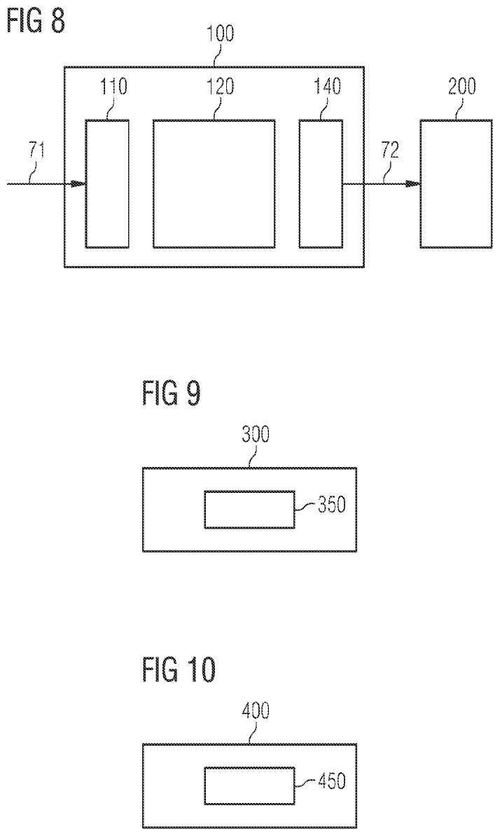

FIG. 10 shows a schematic block diagram illustrating non-transitory computer-readable data storage medium 400 incorporating teachings of the present disclosure, i.e. a data storage medium 400 comprising executable program code 450 configured to, when executed (e.g. by the apparatus 100), perform one or more of the methods described herein, in particular the method as has been described with respect to FIG. 1 through FIG. 7 in the foregoing.

In the foregoing detailed description, various features are grouped together in the examples with the purpose of streamlining the disclosure. It is to be understood that the above description is intended to be illustrative and not restrictive. It is intended to cover all alternatives, modifications and equivalence. Many other examples will be apparent to one skilled in the art upon reviewing the above specification, taking into account the various variations, modifications and options as described or suggested in the foregoing.

What is claimed is:

1. A computer-implemented method for enhancing reliability of bootstrapping for information extraction, IE, the met comprising
performing relation extraction, RE, to acquire a seed instance including a pair of entities and relationship information between the pair of entities;
finding seed occurrences which match to the seed instance in a document collection;
generating a set of extraction patterns corresponding to the relationship information by clustering the seed occurrences, wherein each of the extraction patterns is mapped to one of clusters of the seed occurrences;
generating a graph which represents similarity between the extraction patterns based on word embedding vectors for each of the extraction patterns;
identifying at least one noisy extraction pattern among the set of the extraction patterns based on the similarity and a pre-defined threshold; and
rectifying the set of extraction patterns by removing the identified noisy extraction pattern from the graph.

2. The method of claim 1, wherein the word embedding vectors for each extraction pattern are generated based on a sum of results of embedding all words before the pair of entities, between the pair of entities, and/or after the pair of entities of seed occurrences included in a corresponding cluster in the document collection.

3. The method of claim 1, wherein the graph comprises a spanning tree including the extraction patterns connected by edges which does not configure a closed loop.

4. The method of claim 3, wherein a length of each edge in the spanning tree is proportional to a similarity value of two extraction patterns which are connected by said edge.

5. The method of claim 1, wherein identifying includes if an extraction pattern has a similarity value to a neighbor extraction pattern connected to the extraction pattern which is below the pre-defined threshold, deciding that the extraction pattern is a noisy extraction pattern.

6. The method of claim 1, wherein identifying includes if an extraction pattern has an average of similarity values to at least two neighbor extraction patterns connected to the extraction pattern which is below the pre-defined threshold, deciding that the extraction pattern is a noisy extraction pattern.

7. The method of claim 1, wherein identifying includes if an extraction pattern has a maximum of similarity value to neighbor extraction patterns connected to the extraction pattern which is below the pre-defined threshold, deciding that the extraction pattern is a noisy extraction pattern.

8. The method of claim 7, wherein identifying further includes: if the extraction pattern has a maximum of similarity value to a neighbor extraction pattern which is above the pre-defined threshold, and if the extraction pattern has a similarity value to a neighbor extraction pattern which is below the pre-defined threshold, removing an edge corresponding to the similarity value below the pre-defined threshold.

9. The method of claim 1, further comprising:
comparing a candidate instance corresponding to a specific extraction pattern included in the rectified set with a word, which is predicted by a language model, LM, based on a portion of the candidate instance; and
determining that the specific extraction pattern has same semantics as the relationship information of the seed instance in case the word predicted by the LM matches to another portion of the candidate instance.

10. The method of claim 9, wherein the word predicted by LM comprises at least one of:
a first entity of the candidate instance,
a second entity of the candidate instance, and/or the specific extraction pattern corresponding to the candidate instance.

11. The method of claim 9, wherein determining includes deciding that the word predicted by the LM matches to another portion of the candidate instance in case a type of the word predicted by the LM is identical to a type of another portion of the candidate instance.

12. The method of claim 9, wherein the LM is pre-trained by unstructured corpora such that the LM is equipped with a function of predicting the word based on the portion of the candidate instance.

13-15. (canceled)
